(19) United States
(12) Patent Application Publication
(10) Pub. No.: US 2008/0139380 A1
(43) Pub. Date: Jun. 12, 2008

(54) CONCENTRATION OF ACTIVE CATALYST SLURRY

(75) Inventors: Bruce E. Reynolds, Martinez, CA (US); Axel Brait, San Rafael, CA (US)

Correspondence Address: CHEVRON CORPORATION, P.O. BOX 6006, SAN RAMON, CA, 94583-0806, US

(73) Assignee: CHEVRON U.S.A. INC., San Ramon, CA (US)

(21) Appl. No.: 11/567,628

(22) Filed: Dec. 6, 2006

(51) Int. Cl. B01J 27/00

(52) U.S. Cl. 502/150

(57) ABSTRACT

This application discloses a process for concentration and deoiling of a slurry catalyst stream for ease of transport to a hydroprocessing unit. The slurry catalyst may then be diluted with oil for use.

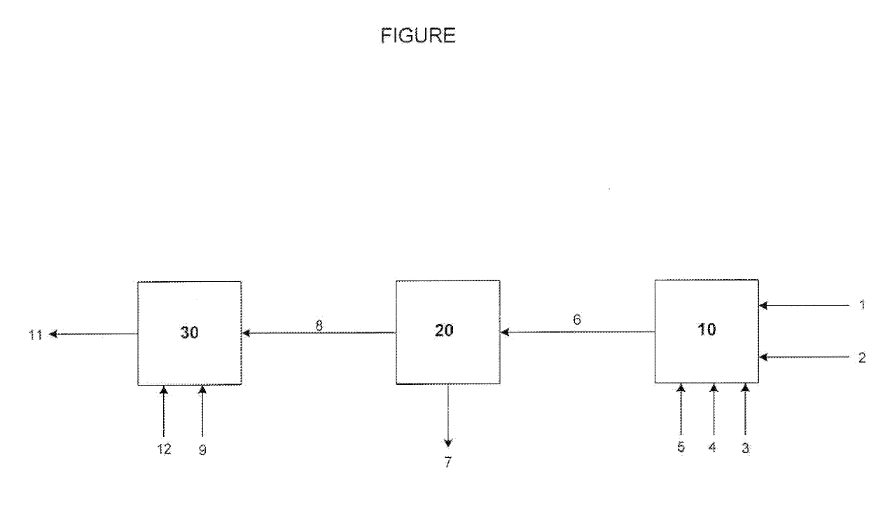

### FIELD OF THE INVENTION

This application discloses a process for concentration and deoiling of an active slurry catalyst stream.

### BACKGROUND OF THE INVENTION

Slurry catalyst compositions, means for their preparation, and their use in hydroprocessing of heavy feeds are known in the refining arts. Some examples are discussed below:

U.S. Pat. No. 4,710,486 discloses a process for the preparation of a dispersed Group VIB metal sulfide hydrocarbon oil hydroprocessing catalyst. Process steps include reacting aqueous ammonia and a Group VIB metal compound, such as molybdenum oxide or tungsten oxide, to form a water soluble oxygen-containing compound such as ammonium molybdate or tungstate.

U.S. Pat. No. 4,970,190 discloses a process for the preparation of a dispersed Group VIB metal sulfide catalyst for use in hydrocarbon oil hydroprocessing. This catalyst is promoted with a Group VIII metal. Process steps include dissolving a Group VIB metal compound, such as molybdenum oxide or tungsten oxide, with ammonia to form a water soluble compound such as aqueous ammonium molybdate or ammonium tungstate.

U.S. Pat. No. 5,053,376 discloses a process for preparing a sulfided molybdenum catalyst concentrate. A precursor catalyst concentrate is formed by mixing together: (i) a hydrocarbonaceous oil comprising constituents boiling above about 1050 degree F.; (ii) a metal compound selected from the group consisting of Groups II, III, IV, V, VIB, VIIB, and VIII of the Periodic Table of the Elements, in an amount to provide from about 0.2 to 2 wt. % metal, based on the hydrocarbonaceous oil; and (iii) elemental sulfur in an amount such that the atomic ratio of sulfur to metal is from about 1/1 to 8/1 then (b) heating the mixture to an effective temperature to produce a catalyst concentrate. Ammonium compounds may also be used in the preparation process.

Following the catalyst synthesis step, the slurry catalyst material of this invention requires concentration. The slurry catalyst is transported in an oil stream. In order to maintain the pumpability of the slurry catalyst, and decrease the volume of material that the metals recovery unit must handle, reduction in the amount of the oil is desirable.

### SUMMARY OF THE INVENTION

This application discloses a process for concentrating a catalyst slurry following catalyst synthesis in order to remove oil and enhance pumpability.

The major steps of the process are as follows: A process for the concentration of an active slurry catalyst found in an oil stream, said process comprising the following steps:
(a) passing a Group VI metal compound and a Group VIII metal compound to a catalyst synthesis unit, where they are combined with an oil, hydrogen sulfide gas, and hydrogen to create an active slurry catalyst in oil;
(b) passing the effluent of step (a) to a catalyst concentration zone, where a concentrated, active catalyst is produced;
(c) passing the concentrated catalyst of step (b) to the site of the hydroprocessing unit, where it is diluted in a dilution zone.

The catalysts slurry is produced at a catalyst concentration that is judged best for its resulting activity. The concentration, however, that is best for the resulting catalyst activity provides an economically impractical volume of slurry from a shipping standpoint. In the past, this has resulted in the major disadvantage of requiring that the catalyst synthesis unit be co-located with the hydroprocessing unit that uses the oil-based catalyst. In order to overcome this problem, we have devised a way to concentrate the catalyst after its synthesis in such a way that the resulting concentrated slurry can be economically shipped from a central catalyst synthesis location. This allows economy of scale, using one catalyst synthesis unit for multiple hydroprocessing unit locations. The concentrated catalyst is rediluted at the hydroprocessing unit location to facilitate ease of handling and ensure the high activity in the hydroprocessing unit.

### BRIEF DESCRIPTION OF THE FIGURE

The FIGURE illustrates the process disclosed in this invention for concentrating and deoiling catalyst slurry following catalyst synthesis.

### DETAILED DESCRIPTION OF THE INVENTION

A group VIII metal compound (stream 1) and a Group VI metal compound (stream 2) enter the Catalyst Synthesis Unit (CSU 10), where it is combined with hydrogen sulfide (stream 3), light vacuum gas oil or carrier oil (stream 4) and hydrogen (stream 5). A preferred Group VIII metal compound is nickel sulfate and a preferred Group VI metal compound is ammonium dimolybdate.

In the catalyst synthesis unit (CSU 10), conditions include a temperature in the range from 80° F. to 200° F., preferably in the range from 100° F. to 180° F., and most preferably in the range from 130° F. to 160° F. Pressure is in the range from 100 to 3000 psig, preferably in the range from 200 to 1000 psig, and most preferably from 300 to 500 psig. The ingredients are mixed in the CSU 10 to form an active slurry catalyst in oil.

The CSU 10 is a continuously stirred tank reactor (CSTR or alternately, perfectly mixed reactor). This type of reactor is employed in order to prevent catalyst agglomeration.

Stream 6, leaving SCU 10 and entering Catalyst Concentration Zone 20 (CCZ 20), comprises a slurry of catalyst plus carrier oil, in a ratio of 10% solids to 90% oil. Stream 7 comprises a recovered carrier oil that is recycled back to CSU 10 or goes to a storage tank that eventually feeds to CSU 10.

A variety of processes is available to concentrate and deoil the slurry catalyst in the CCZ 20. A preferred method involves concentrating the solids in the oil slurry, then washing or filtering using a solvent. Especially useful are well-known filtration techniques such as cross-flow filtration that allows from about 30% to about 80% of the oil to be separated and recycled to the Catalyst Synthesis Unit 10. A preferred range is removal of from about 40% to about 75% of the oil. A concentrated catalyst stream, stream 8 is transported to Dilution Zone 30, which is found at the site of the hydroprocessing unit.

Suitable conditions for operation of CCZ 20 include temperature in the range from about 194F to about 212F. Pressure is in the range from about 100 to about 120 psi for initial concentration and 90 psi for solvent filtration.

The appropriate choice of oil for the Dilution Zone 30 may be the same as that used in the Catalyst Synthesis Unit 10. The oil used (stream 12) is dependent on availability and economics. Ideally, it should be a high flash point oil for ease of shipping (in order to avoid environmental and safety hazards) with a low pour point to minimize low temperature handling issues (cold flow problems). Typical streams would be light vacuum gas oils, heavy atmospheric gas oils, and other streams with modest viscosity (4-10 cst at 100 C). Higher density streams at low viscosity are best.

Makeup hydrogen may be added in stream 9. Active catalyst slurry, suitable for use in hydroprocessing, exits the Dilution Zone as stream 11.

Factors used in selecting membranes for use in concentration, washing and filtration include permeate flux rate, filtrate quality, chemical compatibility of the membrane, mechanical strength of the membrane and temperature tolerance of the membrane.

What is claimed is:

1. A process for the concentration of an active slurry catalyst found in an oil stream, said process comprising the following steps:
(a) passing a Group VI metal compound and a Group VIII metal compound to a catalyst synthesis unit, where they are combined with an oil, hydrogen sulfide gas, and hydrogen to create an active slurry catalyst in oil;
(b) passing the effluent of step (a) to a catalyst concentration zone, where a concentrated, active catalyst is produced;
(c) passing the concentrated catalyst of step (b) to the site of the hydroprocessing unit, where it is diluted with oil in a dilution zone.

2. The process of claim 1, in which the Group VI metal compound is ammonium molybdate.

3. The process of claim 1, in which the Group VIII metal compound is nickel sulfate.

4. The process of claim 1, wherein the effluent of step (a) comprises a catalyst slurry in a ration of 10% solids to 90% oil.

5. The process of claim 1, wherein from 30% to 80% of the oil is removed from the slurry in step (b).

6. The process of claim 5, wherein from 40% to 80% of the oil is removed from the slurry in step (b).

7. The process of claim 1, which oil removed from step (b) is recycled to step (a) or is passed to storage.

8. The process of claim 1, wherein the oil used for dilution has a viscosity in a range from 4 to 10 cSt at 100 C.

9. The process of claim 1, wherein the diluent stream is a vacuum gas oil or a heavy atmospheric gas oil.

10. The process of claim 1, in which conditions in step (a) include a temperature in the range from 80° F. to 200° F., preferably in the range from 100° F. to 180° F., and most preferably in the range from 130° F. to 160° F.

11. The process of claim 10 in which conditions in step (a) include pressure in the range from 100 to 3000 psig, preferably in the range from 200 to 1000 psig, and most preferably from 300 to 500 psig.

12. The process of claim 1 in which conditions in step (b) comprise a temperature in the range from about 194F to about 212F.

13. The process of claim 1, in which conditions in step (b) comprises a pressure in the range from about 100 to about 120 psi for initial concentration and 90 psi for solvent filtration.

14. The process of claim 1, in which concentration of step (b) comprises concentrating the solids in the oil slurry, then washing or filtering using a solvent.

15. The process of claim 14, in which cross-flow filtration is employed.
